(19) United States
(12) Patent Application Publication
(10) Pub. No.: US 2025/0272550 A1
(43) Pub. Date: Aug. 28, 2025

(54) MEMRISTIVE SELF-LEARNING SPIKING FEEDBACK LOOPS-BASED NEURAL NETWORKS WITH SPIKE-TIMING-DEPENDENT PLASTICITY (STDP)

(71) Applicants: Maxim TALANOV, Novi Sad (RS); Victor EROKHIN, Parma (IT); Alexander TOSCHEV, Dubai (AE)

(72) Inventors: Maxim TALANOV, Novi Sad (RS); Victor EROKHIN, Parma (IT); Alexander TOSCHEV, Dubai (AE)

(21) Appl. No.: 19/061,603

(22) Filed: Feb. 24, 2025

Related U.S. Application Data
(60) Provisional application No. 63/556,551, filed on Feb. 22, 2024.

(51) Int. Cl. G06N 3/049; G06N 3/088

(52) U.S. Cl. CPC G06N 3/049; G06N 3/088

(57) ABSTRACT

The present disclosure relates to a memristive self-learning system for a hardware implementation. The system is implemented with a plurality of memristive devices, the memristive devices being connected according to one of a bio-inspired networks. The system further is provided with a loops-based spiking neural network (SNN) with spike-timing-dependent plasticity (STDP). The SNN is implemented with a plurality of feedback loops, capable of self-learning and self-adjustment of weights of SNN connections. The SNN is combined with triggering leaky integrate-and-fire hardware neurons and/or the memristive devices and memristive synapses that are configured to sense triggering input signals from input channels, and the leaky integrate-and-fire hardware neurons and the memristive synapses are connected according to bio-inspired networks with the plurality of the feedback loops.

### RELATED APPLICATIONS

This application relates to and claims priority to U.S. patent application Ser. No. 63/556,551 (MEMRISTIVE SELF-LEARNING SPIKING FEEDBACK LOOPS-BASED NEURAL NETWORKS WITH SPIKE-TIMING-DEPENDENT PLASTICITY (STDP)), filed on Feb. 22, 2024, which is incorporated herein by reference.

### BACKGROUND

The present invention generally relates to spiking neural networks (SNN). More specifically, the present invention relates to a memristive feedback-driven self-learning system for a hardware implementation where memristive devices are integrated into a SNN, allowing for dynamic changes in resistance based on historical activity, and thereby facilitating spike-timing-dependent plasticity (STDP).

The field of SNNs has gained significant attention due to its potential to simulate and mimic the natural learning processes of biological neural systems. The traditional SNN designs, however, cannot often effectively implement self-learning mechanisms that leverage time as a fundamental physical dimension.

Recent advancements in the SNN technology have introduced novel principles for self-learning, emphasizing the importance of time as a physical dimension in the learning mechanisms of SNNs, the utilization of STDP as a core learning rule, and the organization of SNNs with feedback loops to enable dynamic and adaptive processing.

To implement these principles, modern SNN architectures can be designed with asynchronous inputs to every synapse of every neuron. For example, as disclosed in the present disclosure, in such architectures, synapses can be implemented as non-volatile memristive devices, while neurons may be implemented as volatile memristive devices.

### SUMMARY

In one aspect, the present invention provides a memristive self-learning system for a hardware implementation. The system is implemented with a plurality of memristive devices, the memristive devices being connected according to one of a bio-inspired networks. The system further is provided with a loops-based spiking neural network (SNN) with spike-timing-dependent plasticity (STDP). The SNN is implemented with a plurality of feedback loops, capable of self-learning and self-adjustment of weights of SNN connections. The SNN is combined with triggering leaky integrate-and-fire hardware neurons and/or the memristive devices and memristive synapses that are configured to sense triggering input signals from input channels, and the leaky integrate-and-fire hardware neurons and the memristive synapses are connected according to bio-inspired networks with the plurality of the feedback loops. The hardware can be a locomotion management of implants system and/or a robotic system.

In another aspect, the present invention provides a memristive feedback-driven self-learning system implemented in a hardware. The system can include a plurality of memristive devices, each memristive device of the plurality of memristive devices are configured to mimic synaptic connections and/or neurons and a spiking neural network (SNN) with spike-timing-dependent plasticity (STDP). The SNN can be implemented with a plurality of feedback loops, capable of self-learning and self-adjustment of weights of SNN connections. Further, the SNN is combined with triggering leaky integrate-and-fire hardware neurons and/or the memristive devices and memristive synapses that are configured to sense triggering input signals from input channels, and the leaky integrate-and-fire hardware neurons and the memristive synapses are connected according to bio-inspired networks with the plurality of the feedback loops. The bio-inspired networks are selected from the group comprising a spinal central pattern generator (CPG), thalamocortical loop, prefrontal cortex-limbic system loops, hippocampus or their combinations.

### BRIEF DESCRIPTION OF THE DRAWINGS

In order that the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, aspects of the invention will be described and explained with additional specificity and detail through the use of the accompanying drawings.

FIG. 1 depicts a representation of applications of the memristive self-learning SNN, implantable for medical purposes and robotic system management according to embodiments of the invention;

FIG. 2 depicts an architecture of the self-learning spiking neural network (SNN) with feedback loops according to embodiments of the invention;

FIG. 3 depicts a minimal SNN architecture of a cortical column according to embodiments of the invention;

FIG. 4 depicts a minimal SNN with one feedback loop according to embodiments of the invention;

FIG. 5 depicts an output of the minimal SNN schematic presented in FIG. 4 according to embodiments of the invention;

FIG. 6 depicts an architecture of the spinal CPG SNN feedback loops according to embodiments of the invention;

FIG. 7 depicts a diagram of the polyaniline-based memristive device according to embodiments of the invention;

FIG. 8 depicts a calculated voltage-current characteristics of the ionic component of the total current according to embodiments of the invention;

FIG. 9 depicts a calculated voltage-current characteristics of the electronic component of the total current according to embodiments of the invention;

FIG. 10 depicts an spike-timing-dependent plasticity (STDP) window for the memristive device according to embodiment of the present invention-relative conductance changes for different delay Δt values; the inset shows the shapes of presynaptic (black) and postsynaptic (grey) potential pulses according to embodiments of the invention; and

FIG. 11 depicts a schematic evolution of metal bridges (conducting filaments) in Cu/PPX/ITO memristors and the consequent quantum conductance effect according to embodiments of the invention.

### DETAILED DESCRIPTION

Reference to “a specific embodiment” or a similar expression in the specification means that specific features, structures, or characteristics described in the specific embodiments are included in at least one specific embodiment of the present invention. Hence, the wording “in a specific embodiment” or a similar expression in this specification does not necessarily refer to the same specific embodiment.

Hereinafter, various embodiments of the present invention will be described in more detail with reference to the accompanying drawings. Nevertheless, it should be understood that the present invention could be modified by those skilled in the art in accordance with the following description to achieve the excellent results of the present invention. Therefore, the following description shall be considered as a pervasive and explanatory description related to the present invention for those skilled in the art, not intended to limit the claims of the present invention.

Reference to “an embodiment,” “a certain embodiment” or a similar expression in the specification means that related features, structures, or characteristics described in the embodiment are included in at least one embodiment of the present invention. Hence, the wording “in an embodiment,” “in a certain embodiment” or a similar expression in this specification does not necessarily refer to the same specific embodiment.

The present disclosure is directed to a novel spiking neural network (SNN) system for a hardware implementation that uses memristive devices to mimic the structure and functionality of biological neural systems. These devices enable self-learning and adaptability through feedback loops and the spike-timing-dependent plasticity (STDP) learning rule.

The self-learning principles described in the present disclosure can be applied to various SNN architectures, including those for controlling spinal central pattern generators for locomotion in implants and robotic systems, enabling navigation tasks in robotic systems through hippocampal-like structures, supporting emotional drives through limbic systems combined with prefrontal cortical models, facilitating stroke rehabilitation through thalamocortical loops, improving computer vision tasks through visual cortex-inspired models, and enhancing natural language processing and related tasks by emulating the language centers of the brain.

This novel approach demonstrates significant potential to advance SNN technology across diverse applications, providing a foundation for improved adaptability and efficiency in neural-inspired systems.

The non-limiting key features and core principles of the present disclosure are described below:
Feedback-Driven Learning: Feedback-Driven Learning incorporates bio-inspired feedback loops for efficient processing and self-organization of neural activity.
   Memristive Devices: Memristive Devices are the foundation for synaptic and neuronal components, enabling dynamic resistance adjustments based on signal history.
   Applications: Applications demonstrate potential use cases for example, in motor control (spinal central pattern generators), navigation (hippocampus), reasoning and emotion (prefrontal cortex and limbic system), and rehabilitation (thalamocortical loops).
   Minimal and Scalable Implementations: Minimal SNNs with a few neurons for testing feedback mechanisms; scalable designs can reach thousands of neurons and thousands of synapses for complex bio-plausible systems.
   Time as a Physical Dimension: The proposed SNN architecture incorporates time as a critical factor in learning, aligning with biological neural dynamics.
   Spike-Timing-Dependent Plasticity (STDP): STDP is a key learning rule where the timing of spikes between neurons influences synaptic strength, allowing for adaptive learning.
   Feedback Loop Organization: The SNN is structured with feedback loops that enhance learning and coordination among neurons, akin to biological systems.

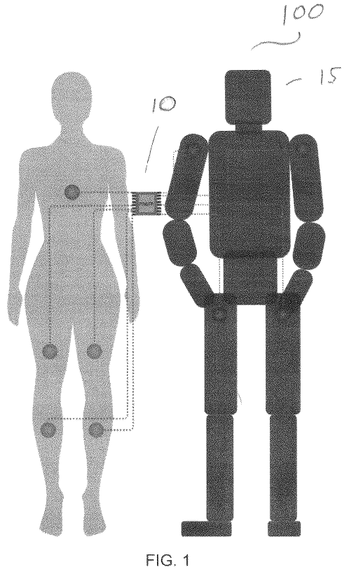

The architecture employs both volatile and non-volatile memristive devices. The volatile memristive neurons are used for real-time processing and adaptation. non-volatile memristive synapses act as memory elements that retain information about synaptic strength over time, crucial for long-term learning. According to embodiment of the present disclosure, as illustrated in FIG. 1, the memristive devices are integrated into the SNN, allowing for dynamic changes in resistance based on historical activity, thereby facilitating STDP.

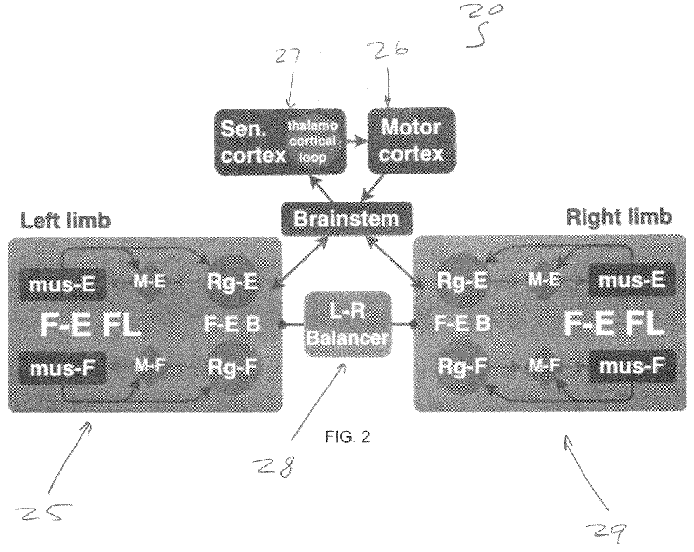

According to embodiments of the present invention, as illustrated in FIG. 1, a memristive feedback-driven self-learning system 100 can be implemented in a hardware via a feedback loops-based spiking neural network (SNN) 20 with spike-timing-dependent plasticity (STDP), for example, shown in FIG. 2, with asynchronous inputs to every synapse of every neuron. Memristive devices 70, shown in FIG. 7, according to embodiment of the present invention can be implemented as non-volatile (for synapses) and as volatile (for neurons). The hardware 15 can be a locomotion management system of implants and/or robotic system 15 (shown in FIG. 1).

The principles of self-learning can be used for the organization of the SNN 20 with STDP and feedback loops including a spinal central pattern generator (CPGs) 10 that is shown in FIG. 1 for the locomotion management of implants and/or robotic system 15 (shown in FIG. 1). The topology of the neuronal circuits responsible for generation of complex rhythmic pattern, for example, CPG, is largely undetermined. It has been shown, however, that epidural electrical stimulation (EES) can facilitate complex movements in SCI animals and patients by providing the sensory (e.g., electrical) input to the CPG circuits. Embodiments of the present invention provide that, while the topology of the CPG circuits mostly remains unknown, a resister-bases reconstruction of the neuronal circuitry of the spinal cord CPG, which is responsible for a motor pattern formation, allows for generating a computational model (in silico) that can be implemented in a single-board computer. The resulting in silico computational model of the neuronal topology can be then implemented in a CPG implementation device that allows for the generation of the electrical signals compatible with the biological neuronal stimulation of the muscles of a SCI patient to activate motor functions in limbs of a SCI patient.

Similarly, for example, hippocampus can be used for the robotic system's 15 navigation, limbic system and frontal and prefrontal cortex for emotional drives including motivation, and reasoning, thalamocortical loops for stroke rehabilitation, and visual cortex for computer vision tasks, language centres of the brain.

FIG. 2 illustrates an architecture of SNN 20, according to embodiments of the present invention. The architecture of the SNN 20 can include feedback loops with, for example, limb rhythm generators (1) Rg-E (extensor) and Rg-F (flexor) for both legs; (2) balancing inhibitory projections of rhythm generators (F-E B); (3) motor neurons of flexor and extensor (M-F and M-E); (4) muscles of flexor and extensor of both legs (mus-F and mus-E); (5) balancing nuclei (commissural projections) of two legs (L-R Balancer); (6) sensory projections go from limbs to the brainstem and the sensory cortex with thalamocortical loop; and (7) motor cortex, generates neuronal activity projected down to the spinal cord circuits.

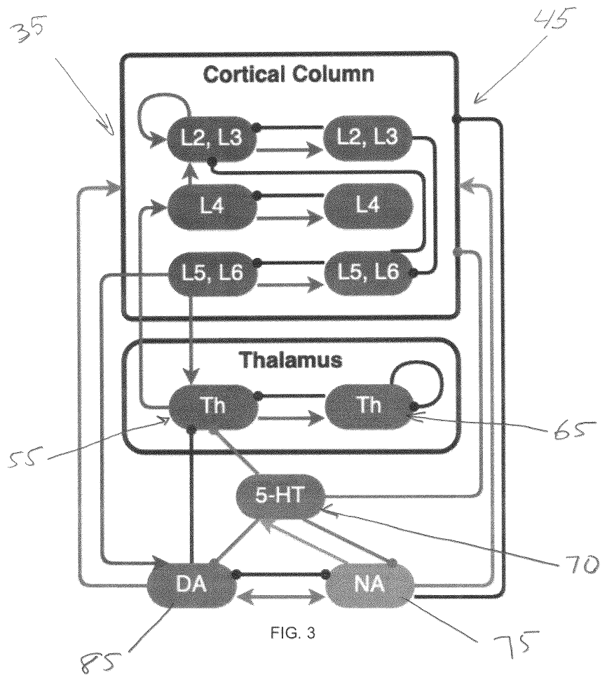

FIG. 3 illustrates another exemplary embodiment of the SNN 20 architecture of cortical column, and more specially: (1) L2, . . . , L6 layers of cortical column excitatory 35 and inhibitory 45 nuclei; (2) inhibitory 55 and excitatory 65 of the thalamus (Th); (3) serotonin subsystem of the brain (5-HT); (4)—dopamine subsystem of the brain 85 (DA); (5)—nor-adrenaline subsystem of the mammalian brain (NA) 75; →excitatory projections; [symbol] inhibitory projections.

As shown in FIG. 2, the SNN 20 consists of three levels of feedback loops, namely, a limb muscle coordination feedback loop F-E FL 25, a brain sensory cortex thalamocortical loops and motor cortex projections 27, and a brain to spinal cord tracts and spinal F-E FL 29.

The limbs level F-E FL consists of pairs of rhythm generators Rg-E (extensor) and Rg-F that are balanced by inhibitory balancer F-E B. Rhythm generators have projections to motor neuronal pools M-F, M-E that project to muscles mus-F and mus-E. Muscles in their turn have excitatory feedback projections (afferents) to M-F, M-E and rhythm generators Rg-E and Rg-F as well as there are sensory afferents from insole depicted as arrows: mus-E→M-E, mus-E→Rg-E; mus-F→M-F, mus-F→Rg-F. There are limb feedback loops F-E FL for each pair of flexor-extensor muscles of the ankle, knee, and hips. Left and right legs are balanced via inhibitory projections of the L-R Balancer 28.

Turning back to FIG. 3, the sensory afferents project through the spinal circuitry to the brain stem and sensory cortex of the brain which has the thalamocortical loop (shown in FIG. 3) that forms the brain level of the feedback loops of the SNN 20. The sensory cortex has projections to the motor cortex that project neuronal activity back to the spinal cord F-E FLs 25. The most high-level feedback loop is from limbs F-E FLs 25 to the sensory cortex 27 to the motor cortex 26 and back to limbs F-E FLs 25.

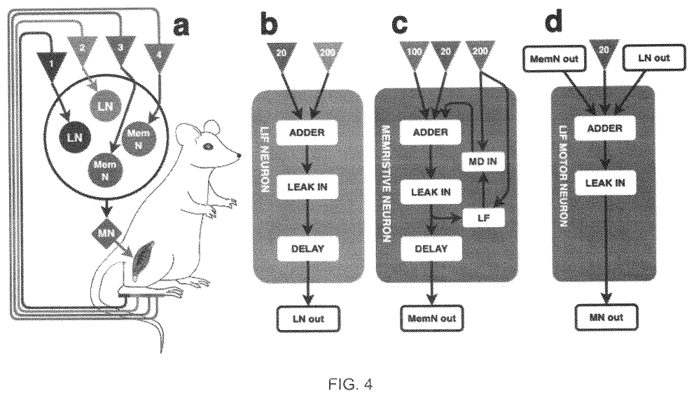

FIGS. 4(a)-4(d) illustrate the SNN 20 with a single feedback loop. FIG. 4(a) shows leaky integrate (LN) and fire neuron, memristive synapse (MemN-LIF), and motor neuron (MN) and muscle. While references (1, 2, 3, 4) illustrate the feedback loops from the insole of the rat's foot. FIG. 4(b) shows leaky integrate and fire neuron (LIF NEURON) and leaky integrator (LEAK IN). FIG. 4(c) shows learning feedback (LF) and-memristive device integrator (MD IN). FIG. 4(d) shows the output of memristive (MemN out) and leaky integrate (LN) output and neurons (LIF). The output of the motor neuron (MN out) is also shown.

The minimal memristive feedback loop (FIG. 4(a)) is organized from the foot triggering inputs (1, 2, 3, and 4) thus triggering leaky integrated and fire neurons (LNs) 1 and 2, and later memristive neurons (MemNs) 3 and 4. Two MemNs (FIG. 4(c)) have memristive synapses implementing STDP via learning feedback (LF) and memristive device integrator (MD IN) that contains the memristive device 70 (shown in FIG. 7), the rest of the neurons have static synapses as illustrated in FIGS. 4(b) and 2(d).

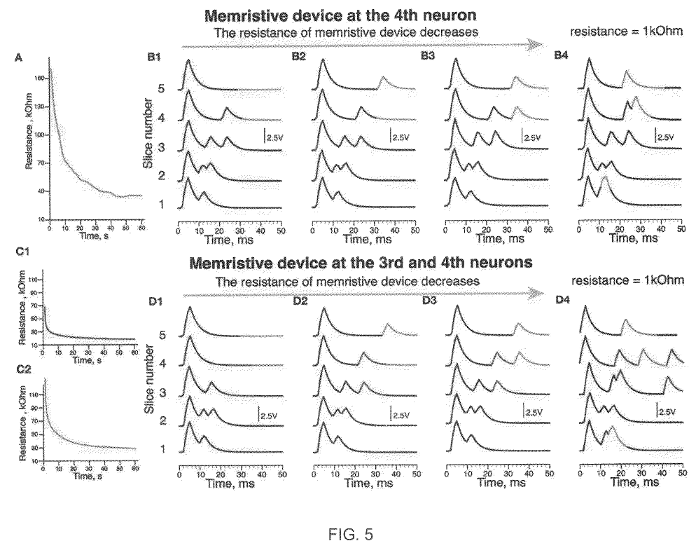

The self-organization of the output memristive neuronal electrical pattern is shown in FIGS. 5B1-B4 and 5D1-D4. The first series of experiments was dedicated to the self-organization of the locomotion pattern due to the self-learning of 1 memristive device, in FIG. 4(a). The FIG. 5B1-B4 indicate the effective, during 60 seconds, self-learning of the memristive device and correct placement of the MemN response. FIG. 5A illustrates training of 2 MemNs (FIG. 5A) and indicates effective self-organization of the output pattern resembling the spinal walking pattern depicted in FIG. 5D1-D4. FIGS. 5A, C1, and C2 indicate the changes in memristive device resistance during 1 MemN (FIG. 5A) and 2 MemNs (FIG. 5C1, C2).

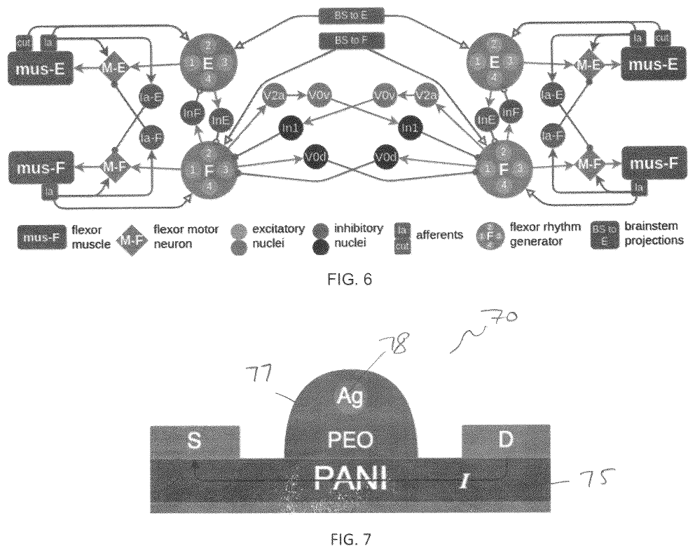

FIG. 6 illustrates spinal feedback loops. In particular, the following designations are used in FIG. 6: mus-F, mus-E are muscles of flexor and extensor; M-E, M-F motor neurons (flexor and extensor); Ia-E, Ia-F—Ia inhibitory interneurons; E, F—rhythm generators of flexor and extensor; InF, InE—inhibitory interneurons of balancing rhythm generators of flexor and extensor; BS to F, BS to E—brainstem to rhythms generators projections; V2a, V0v—excitatory interneurons and V0d, In1—inhibitory interneurons of L-R balancer. Filled arrows-static synapses, empty arrows-memristive (STDP) synapses.

While in FIG. 4 memristive SNN 20 is represented at its starting point of the technical evolution and FIG. 6 illustrates the detailed complete circuitry of the spinal SNN 20 feedback loops containing: flexor (mus-F) and extensor (mus-E) muscles that have projections from/to motor neurons M-F and M-E forming the first level of feedback loops as well as to rhythm generators of flexor (F) and extensor (E). Minimal memristive implementation corresponds to the circuitry described above E→M-E→mus-E→M-E→E. The balancing inhibitory projections of motor neuronal pools are indicated as Ia-E and Ia-F, whereas InF and InE balance F and E rhythm generators. Left and right limbs are balanced (FIG. 2L-R Balancer) via 4 symmetrical projections F→V2a→V0→In1 [symbol] F and F→V0d [symbol] F, where [symbol] —stands for inhibitory projection and → stands for excitatory.

Complete minimal self-learning SNN 20 with feedback loops having the following memristive neurons and synapses:

| | |
|---|---|
| First Leg | Extensor: E (rhythm generator) = 4 |
| | neurons with 8 memristive synapses; InE = |
| | 1 neuron with 8 static synapses, M-E = 1 |
| | neuron with 2 static synapses; Flexor: F |
| | (rhythm generator) = 4 neurons, 4 |
| | memristive synapses; InE = 1 neuron, 8 |
| | static synapses; M-E = 1 neuron with 2 |
| | static synapses; Total: neurons = 12, |
| | memristive synapses = 12, static |
| | synapses = 20. |
| Second Leg | Total: neurons = 24, memristive |
| | synapses = 24, static synapses = 40. |

According to embodiments of the present invention, the following are the steps of the memristive self-learning SNN 20 from the minimal memristive schematic with 5 neurons and 2 memristive synapses (FIG. 4a) first scale up to complete circuitry with 24 neurons, 24 memristive synapses, 40 static synapses implementing the processing of the motor cortex data with outputs from motor neurons and muscles, second scale up to 2000 neurons (volatile), 500 000 (non-volatile) memristive synapses. Precise parameters of the bio-plausible scale SNN 20 with feedback loops are Total: 1754 neurons, 478 200 synapses; M-E, M-F=400 synapses per neuron; Ia=300 interneurons; Renshaw=200 cells; Ia afferents=100 fibres. E and F rhythm generators=200 interneurons.

FIG. 7 illustrates the memristive device 70 according to embodiments of the present invention. Memristive devices 70 can be resistors with memory: the current value of the resistance depends on the history of their involvement in the signal transfer processes. Different types of memristive devices 70 can be used. In particular, the memristive device 70 shown in FIG. 7, based on a polyaniline active layer can be used.

According to embodiments of the present invention, the memristive devices 70 can be based on the heterojunction, where an active layer 70 of, for example, polyaniline is in a contact an electrolyte layer 77. The electrolyte layer 77 can be solid or liquid. A wire 78, for example, a silver wire is inserted in the active layer 70. Resistive switching of the device is due to the redox reactions within the active layer 70, involving ions motion between the active layer 70 layer and the electrolyte layer 77. The oxidized form of polyaniline is a conductive layer while the reduced form is an insulant.

The oxidation-reduction reactions of the can be described by Equation 1 below:

$${PANI}^{+} {Cl}^{-} ( emeraldine salt ) + {Li}^{+} + {e}^{-} \overleftarrow{\to } PANI ( leucoemeraldine ) + LiCl , Ag + {ClO}_{4}^{-} \overleftarrow{\to } {AgClO}_{4} + {e}^{-} .$$

According to the connection to the external circuit, the device 70 can be considered as a two-terminal one, as S and D electrodes are connected. However, to understand better the working principle, it can be viewed separately as the ionic and electronic contributions of the total current.

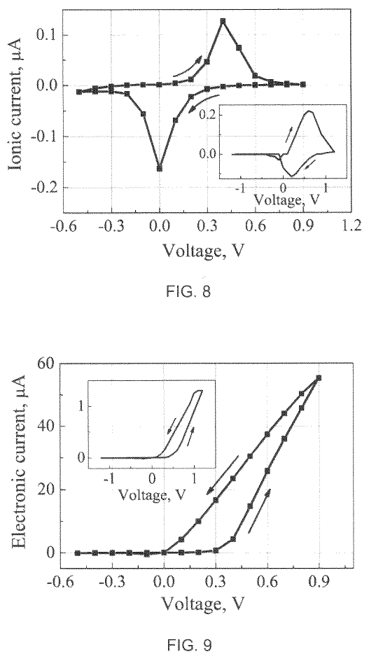

FIGS. 8 and 9 illustrate the Experimental and calculated dependences of the currents of the memristive device 70 described above for the ionic current and electronic current, respectively.

Regarding a possible neuromorphic application, the memristive device 70 has two key features: the memristive device 70 voltage-current characteristic has hysteresis and the memristive device 70 reveals the rectification behavior. The rectification behavior is attributed to the fact that both oxidizing and reducing potentials of polyaniline are in a positive range of the applied voltage. Thus, the device 70 is a volatile, that is if the applied voltage is switched off, it will go into an insulating state.

The advantage of the memristive device 70 with respect to memristors, based on filament growth with successive variation of their resistance is the fact that ON and OFF switching voltages are the same for all devices of this type and different cycles of the same device (even if absolute values of the current can vary).

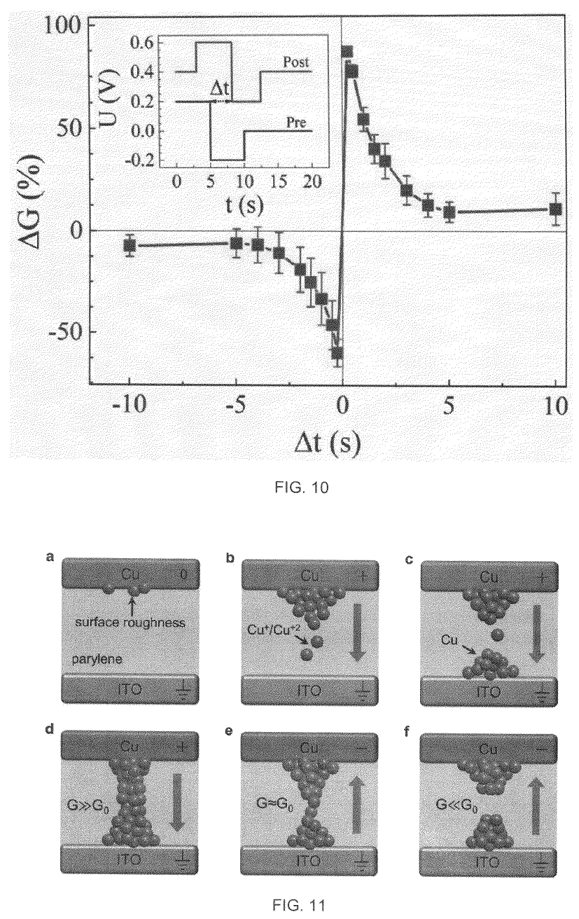

In addition, the memristive device 70 can work not only in the direct current (DC) mode but also in a spiking mode, demonstrating the possibility of realizing circuits, and performing bio-plausible learning according to Spike-Timing Dependent Plasticity (STDP), as shown in FIG. 10.

As shown in FIG. 10, the presented dependence is a basis of unsupervised learning, establishing an automatically causal relationship. This property has been used for the realization of the first step of the neuro-prosthesis, described above, capable of making adaptations, according to special features of a particular patient, that can also be considered as a personalized prosthesis, capable also of varying its importance properties if the external (displacement to the other zone (for example, from the flat landscape to mountains); variation of working conditions, etc.) and internal (age, some not related diseases, etc.) conditions were changed. Summarizing, the memristive device 70 has important properties to be considered as an artificial synapse analogue, which has been directly demonstrated using it for the connection of live nervous cells from the rat cortex. It is an ideal element for implementation of short-term plasticity.

On the other hand, for some purposes, it is necessary to have elements, that allow long-term plasticity, namely non-volatile elements with resisting switching. There are a variety of devices of such type, which working principle are mainly based on the formation of conducting filaments in the insulating layer with its successive oxidation and/or reduction, resulting in resisting switching. The non-volatile nature of such devices is due to the resistance switching occurs only when the polarity of the applied voltage is changed, otherwise, the device maintains its resistance state. According to embodiments of the present invention, a particular realization of a non-volatile memristive device, passed on the growth of conducting filaments in the parylene insulating layer. It is to be noted that perylene is an absolutely inert material, allowed also for medical applications.

FIG. 11 illustrates the mechanism of the resistance switching according to embodiment of the present invention. More specifically, FIG. 11 depicts the schematic evolution of metal bridges (conducting filaments) in Cu/PPX/ITO memristors and the consequent quantum conductance effect. FIG. 11(a) shows fragment of a pristine sandwich structure, having some surface irregularities on the top electrode. The orange pellets represent Cu atoms. FIG. 11(b) shows a positive voltage being applied to the top electrode of the structure; copper ions begin to move to the cathode (ITO) under the action of an electric field. FIG. 11(c) shows copper ions reach the bottom electrode and being reduced, so a conductive filament begins to grow. FIG. 11(d) shows the conductive filament has been fully formed, and where quantized conductance has not been observed. FIG. 11(e) shows a negative voltage being applied to the top electrode. Copper ions begin to move backwards to the top electrode. A quasi-point contact is formed, so the conductance is quantized, becoming approximately equal to G0. FIG. 11(f) shows the conductive filament has ruptured, and conductance is much less than G0.

The foregoing detailed description of the embodiments is used to further clearly describe the features and spirit of the present invention. The foregoing description for each embodiment is not intended to limit the scope of the present invention. All kinds of modifications made to the foregoing embodiments and equivalent arrangements should fall within the protected scope of the present invention. Hence, the scope of the present invention should be explained most widely according to the claims described thereafter in connection with the detailed description, and should cover all the possibly equivalent variations and equivalent arrangements.

The present invention can be a system, a method, and/or a computer program product. The computer program product can include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the present invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the present invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form described. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

### REFERENCES

Ausborn, J., Shevtsova, N. A., Caggiano, V., Danner, S. M., & Rybak, I. A. (2019). Computational modeling of brainstem circuits controlling locomotor frequency and gait.eLife,8, e43587. https://doi.org/10.7554/eLife.43587
Juzekaeva, E., Nasretdinov, A., Battistoni, S., Berzina, T., Iannotta, S., Khazipov, R., Erokhin, V., & Mukhtarov, M. (2018). Coupling Cortical Neurons through Electronic Memristive Synapse. Advanced Materials Technologies, 1800350. https://doi.org/10.1002/admt.201800350
Masaev, D. N., Suleimanova, A. A., Prudnikov, N. V., Serenko, M. V., Emelyanov, A. V., Demin, V. A., Lavrov, I. A., Talanov, M. O., & Erokhin, V. V. (2023). Memristive circuit-based model of central pattern generator to reproduce spinal neuronal activity in walking pattern. Frontiers in Neuroscience, 17. https://www.frontiersin.org/articles/10.3389/fnins.2023.1124950
Zhang, H., Shevtsova, N. A., Deska-Gauthier, D., Mackay, C., Dougherty, K. J., Danner, S. M., Zhang, Y., & Rybak, I. A. (2021). The role of V3 neurons in speed-dependent interlimb coordination during locomotion in mice [Preprint]. Neuroscience.https://doi.org/10.1101/2021.09.01.458603

What is claimed is:

1. A memristive self-learning system for a hardware implementation, the system comprising:
a plurality of memristive devices, the memristive devices connected according to one of a bio-inspired networks; and
a loops-based spiking neural network (SNN) with spike-timing-dependent plasticity (STDP), the SNN comprises:
a plurality of feedback loops, capable of self-learning and self-adjustment of weights of SNN connections,
wherein the SNN is combined with triggering leaky integrate-and-fire hardware neurons and/or the memristive devices and memristive synapses that are configured to sense triggering input signals from input channels, and
wherein the leaky integrate-and-fire hardware neurons and the memristive synapses are connected according to bio-inspired networks with the plurality of the feedback loops.

2. The system according to claim 1, wherein the bio-inspired networks are selected from the group comprising a spinal central pattern generator (CPG), thalamocortical loop, prefrontal cortex-limbic system loops, hippocampus or their combinations.

3. The system according to claim 1, wherein the memristive devices are configured to mimic synaptic connections and/or neurons.

4. The system according to claim 1, wherein each feedback loop of the plurality of feedback loops comprises:
a limb muscle coordination feedback loop;
a brain sensory cortex thalamocortical loops and motor cortex projections loops; and
a brain to spinal cord tracts and spinal loop.

5. The system according to claim 1, wherein at least one memristive device of the plurality of memristive devices comprises an active layer, an electrolyte layer, and a wire.

6. The system according to claim 5, wherein the active layer comprises polyaniline and the wire is formed from silver.

7. The system according to claim 5, wherein the at least one memristive device carries out oxidation-reduction reactions as in Equation 1:
$${PANI}^{+} {Cl}^{-} ( emeraldine salt ) + {Li}^{+} + {e}^{-} \overleftarrow{\to } PANI ( leucoemeraldine ) + LiCl , Ag + {ClO}_{4}^{-} \overleftarrow{\to } {AgClO}_{4} + {e}^{-} .$$

8. The system according to claim 1, wherein the hardware is a locomotion management of implants system and/or a robotic system.

9. A memristive feedback-driven self-learning system implemented in a hardware, the system comprising:
a plurality of memristive devices, each memristive device of the plurality of memristive devices are configured to mimic synaptic connections and/or neurons; and
a spiking neural network (SNN) with spike-timing-dependent plasticity (STDP),
wherein the SNN comprises a plurality of feedback loops, capable of self-learning and self-adjustment of weights of SNN connections,
wherein the SNN is combined with triggering leaky integrate-and-fire hardware neurons and/or the memristive devices and memristive synapses that are configured to sense triggering input signals from input channels, and
wherein the leaky integrate-and-fire hardware neurons and the memristive synapses are connected according to bio-inspired networks with the plurality of the feedback loops, the bio-inspired networks are selected from the group comprising a spinal central pattern generator (CPG), thalamocortical loop, prefrontal cortex-limbic system loops, hippocampus or their combinations.

10. The system according to claim 9, wherein the hardware is a locomotion management of implants system and/or a robotic system.

11. The system according to claim 9, wherein at least one memristive device of the plurality of memristive devices comprises an active layer, an electrolyte layer, and a wire.

12. The system according to claim 11, wherein the active layer comprises polyaniline and the wire is formed from silver.

13. The system according to claim 11, wherein the at least one memristive device carries out oxidation-reduction reactions as in Equation 1:
$${PANI}^{+} {Cl}^{-} ( emeraldine salt ) + {Li}^{+} + {e}^{-} \overleftarrow{\to } PANI ( leucoemeraldine ) + LiCl , Ag + {ClO}_{4}^{-} \overleftarrow{\to } {AgClO}_{4} + {e}^{-} .$$
